(19) United States
(12) Patent Application Publication
(10) Pub. No.: US 2025/0210989 A1
(43) Pub. Date: Jun. 26, 2025

(54) METHOD FOR MULTI-LEVEL CONTROL OF AN ELECTRICAL NETWORK; ASSOCIATED COMPUTER PROGRAM

(71) Applicant: Commissariat à l’énergie atomique et aux énergies alternatives, Paris (FR)

(72) Inventor: Hugo JOUDRIER-FAURE, Grenoble Cedex (FR)

(73) Assignee: Commissariat à l’énergie atomique et aux énergies alternatives, Paris (FR)

(21) Appl. No.: 18/985,459

(22) Filed: Dec. 18, 2024

(30) Foreign Application Priority Data
Dec. 20, 2023 (FR) 2314619

(51) Int. Cl. H02J 3/06; H02J 3/38; H02J 13/00

(52) U.S. Cl. CPC H02J 3/06; H02J 3/38; H02J 13/00028; H02J 2203/10; H02J 2300/24

(57) ABSTRACT

A method for controlling a network aggregating sub-networks, with peripheral agents and a central agent, a peripheral agent locally controlling a sub-network, and the central agent overall controlling the network, including the steps of: each peripheral agent performing a local optimization, by distinguishing internal xᵢ and external zᵢ and transmitting: the locales optimal values of the external variables zᵢ^{l}*, lower and upper bounds of the external variables zᵢ^{∨}* and zᵢ^{∧}*, and a value of a local cost function on local optimal values of internal variables fₓⁱ(xᵢ^{l}*), lower and upper bounds of the internal variables fₓⁱ(xᵢ^{∨}*) and fₓⁱ(xᵢ^{∧}*); the central agent performing an overall optimization over all the external variables zᵢ by distributing the contribution of each sub-network by taking into account, for each sub-network, of a deviation from the local cost function evaluated from information transmitted by the corresponding peripheral agent and transmitting the overall optimal values of the external variables zᵢ^{g}*.

The field of the present invention is that of optimal control and, more particularly, the field of optimal control methods of an electrical network aggregating a plurality of electrical sub-networks distributed over a territory.

Such a method is implemented in an infrastructure which comprises an electrical network and a system for controlling the electrical network. The electrical network aggregates a plurality of electrical sub-networks. The sub-networks are connected to a common distribution network.

Electrical sub-networks can be of different kinds, such as electricity production subsystems (photovoltaic panels—PV, wind turbines, thermal units, etc.), electricity consumption subsystems (industrial buildings, offices, dwellings), or subsystems combining production and consumption.

The sub-networks are subject to different requirements, such as the need to ensure a certain production load, the need to satisfy a series of user preferences, etc.

Electrical sub-networks can also be complex as such, aggregating in turn a plurality of electrical components. A sub-network can e.g. be a micro-network formed by a plurality of components (battery storage, PV roofs and shade houses, electric vehicle charging stations, diesel generators, etc.).

The control system includes a plurality of peripheral agents and a central agent, connected to each other via a communication network. While each peripheral agent locally controls an associated electrical sub-network, the central agent controls overall the network.

To this end, each peripheral agent determines a local control strategy to meet an internal objective of the associated subsystem, while the central agent determines an overall control strategy to meet an overall objective of the network, while ensuring the coordination of all the subsystems.

However, electrical subsystems have specific internal objectives, such as minimizing economic costs, maximizing user comfort, minimizing greenhouse gas emissions, etc.

Such internal objectives may differ from the overall objective that is to be optimized in terms of the network as a whole, such as minimizing peak consumption, minimizing CO2 emissions, maximizing flexibility, congestion management, etc.

Methods for controlling such infrastructures are known, based on ADMM (“alternating direction method of multipliers”) and variants thereof. This is, e.g., what is presented in the article Boyd, S., Parikh, N., Chu, E., Peleato, B., & Eckstein, J. (2011) “Distributed optimization and statistical learning via the alternating direction method of multipliers”, Foundations and Trend in Machine learning, 3(1), 1-122, 23 May 2011, DOI:10.1561/2200000016, and the article by Nguyen, T. L., Tran, Q. T., Cairo, R., & Gavriluta, C., “Agent based distributed optimal power flow using ADMM method”, August 2018, CIRED 2018 conference.

The ADMM method makes it possible to distribute the calculations between the remote, peripheral actors and the central actor, at the heart of the network.

The main drawback of such type of method of the prior art is that same requires many iterations to achieve a solution that is both feasible and overall optimal.

All the iterations involve many exchanges between peripheral actors and the central actor through the communication network.

The method is thus very sensitive to the quality of the connection and to the latency problems that can occur on the same network and that can disrupt the communications.

Another method of the prior art is based on the so-called “band” method. The method is presented e.g, in the article K. Utkarsh, F. Ding, C. Zhao, H. Padullaparti and X. Jin, “A Model-Predictive Hierarchical-Control Framework for Aggregating Residential DERs to Provide Network Regulation Services,” 2020 IEEE Power & Energy Society Innovative Smart network Technologies Conference (ISGT), Washington, DC, USA, 2020, pp. 1-5, doi: 10.1109/ISGT45199.2020.9087773.

The method does not require any iteration. It is thus much less sensitive to communication problems between players.

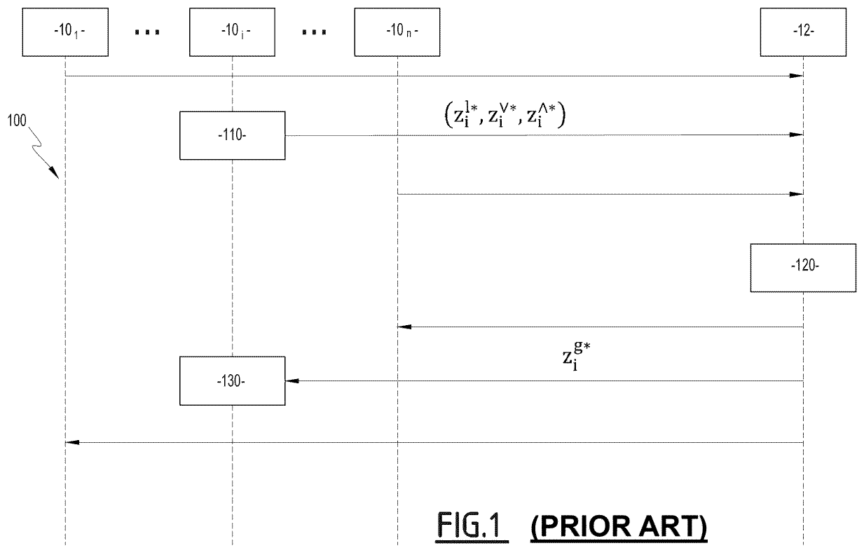

An embodiment of the method will now be presented in greater detail with reference to FIG. 1.

The control method 100 includes three successive steps.

During a first step 110, each peripheral agent 101 (i integer between 1 and n, the number of peripheral agents) determines the optimal internal control strategy thereof, the optimal external control strategy thereof, and optimal overall flexibility margins.

For example, if we consider a sub-network composed of a battery, a building, and a PV roof, the internal control strategy is the detail of the operating points of each of the components of the sub-network (battery, building, PV roof) at the desired time step (minutes per minute, hours per hour, etc.).

The external control strategy is the control strategy at the point of connection of the sub-network to the common distribution network, over the same time step.

The flexibility margins of each of the components are aggregated over each time step in order to determine overall flexibility margins at the connection point.

Such information is the result of the peripheral agent 10ᵢ resolving a local optimization problem as described hereinbelow. The local optimization problem consists of two sets of variables, xᵢ et zᵢ defined as follows:
xᵢ represents the internal variables of the i^{th} sub-network, such as e.g. the charging/discharging power of the battery on each time step, the PV production power on each time step, the consumption power of the building, etc.
zᵢ represents the external variables for the i^{th} sub-networks, such as e.g. the injected power or the drawn-off power at the point of connection to the distribution network, for each time step.

The distinction between internal and external variables makes it possible to separate private information, which is processed locally, from public information, which is shared with the outside world, in the present case the central player playing the role of coordinator of the network.

The optimization algorithm used in the prior art at the local level makes it possible to calculate both the optimal operating point, i.e. the optimal value of each internal variable and of each external value, as well as the lower and upper bounds for each external variable of the micro-network, the interval between the lower and upper bounds defining the margin of flexibility on the corresponding external variable.

The variables xᵢ et zᵢ are thus divided into three groups:
first group:
xᵢ^{l}: the internal control variables of each component of sub-network i, corresponding to a locally calculated internal operating trajectory (hence the index “l”);
zᵢ^{l}: the external control variables of sub-network i, corresponding to a locally calculated external operating trajectory (hence the index “l”);
second group:
xᵢ^{∨}: the lower control bounds of each component of the sub-network i, corresponding to a trajectory of lower internal flexibility, calculated locally;
zᵢ^{∨}: the lower control bounds of sub-network i, corresponding to a trajectory of lower external flexibility, calculated locally;
third group:
xᵢ^{∧}: the upper control bounds of each component of the sub-network i, corresponding to a trajectory of higher internal flexibility, calculated locally;
zᵢ^{∧}: the upper control bounds of the sub-network i, corresponding to a trajectory of higher external flexibility, calculated locally.

Moreover, the trajectories have to comply with a certain number of constraints, in particular physical constraints. For example, it is impossible to store more energy in a battery than the capacity thereof, to exceed a predefined charging or discharging power, not to comply with power balance equations, etc.

All the constraints are described in matrix form as follows:

$${A}_{i} {x}_{i} + {B}_{i} {z}_{i} = {c}_{i}$$

$${A}_{i} {x}_{i}^{⋀} + {B}_{i} {z}_{i}^{⋀} = {c}_{i}$$

$${A}_{i} {x}_{i}^{⋁} + {B}_{i} {z}_{i}^{⋁} = {c}_{i}$$

The matrix of constraints makes it possible to filter the solutions achievable by the sub-network (or trajectories), which satisfy the constraints, from the non-feasible solutions, which do not satisfy the constraints.

Finally, to select the optimal trajectory from all possible trajectories, a cost function has to be defined. For example, and without loss of generalities, the following cost function is minimized:

$${f}_{x} ( {x}_{i} ) + {f}_{z} ( {z}_{i} ) + {α}_{flex} ( {z}_{i}^{⋀} - {z}_{i}^{⋁} )$$

where fₓ is a partial cost function taking into account only internal variables, f_{z} is a partial cost function taking into account only external variables, and α_{flex} a predefined coefficient.

The cost function described herein optimizes the trajectory and, at the same time, determines upward and downward flexibility trajectories by seeking to maximize the gap between the upper and lower trajectories.

The local optimization problem that each peripheral agent 10ᵢ of a sub-network must solve can thus be summarized as follows:

$$( \begin{matrix}{x}_{i}^{l *} , {x}_{i}^{⋁ *} , {x}_{i}^{⋀ *} \\ {z}_{i}^{l *} , {z}_{i}^{⋁ *} , {z}_{i}^{⋀ *}\end{matrix} ) = {arg min}_{{x}_{i} , {z}_{i}} {f}_{x} ( {x}_{i} ) + {f}_{z} ( {z}_{i} ) + {α}_{flex} ( {z}_{i}^{⋀} - {z}_{i}^{⋁} )$$

$$s . t {A}_{i} {x}_{i} + {B}_{i} {z}_{i} = {c}_{i}$$

$${A}_{i} {x}_{i}^{⋀} + {B}_{i} {z}_{i}^{⋀} = {c}_{i}$$

$${A}_{i} {x}_{i}^{⋁} + {B}_{i} {z}_{i}^{⋁} = {c}_{i}$$

where the result of the optimization gives a set of operating points, i.e. values specific to variables and bounds. The optimal values are marked with a “*”.

The method 100 continues with a step 120, carried out by the central agent 12, following the reception, via a communication network, of the values of the external variables of each of the sub-networks i:
(zᵢ^{l}*, zᵢ^{∨}*, zᵢ^{∧}*)

The central agent 12, by solving an overall optimization problem (hence the index “g”), determines new external operating trajectories determined overall for each of the sub-networks:
(z₁^{g}*, . . . , zᵢ^{g}*, . . . , zₙ^{g}*)

The trajectories have to be able to be produced by all the sub-networks, i.e. same should stay within the operating margins communicated:

$${z}_{i}^{⋁ *} \leq {z}_{i}^{g *} \leq {z}_{i}^{⋀ *}$$

It is also possible that the aggregation of the local external operating trajectories of the different sub-networks have to satisfy another set of constraints.

Such is the case e.g. when the central agent seeks to position the infrastructure in flexible markets by participating e.g. in frequency reserve services so as to balance an electrical network, or to respond to network congestion problems.

The other constraints can be written:

$${\sum }_{i} {D}_{i} {z}_{i} = h$$

Or, more synthetically:

Dz=h

Since the overall objective of the central agent is different from the local objectives of each of the edge agents, the cost function associated with the overall optimization problem is different. Same is denoted by:

Step 120 thus corresponds to solving the following optimization problem:

$$( {z}_{1}^{g *} , … , {z}_{i}^{g *} , … , {z}_{n}^{g *} ) = {arg min}_{z} {g}^{′} ( z )$$

$$s . t Dz = h$$

$${z}_{i}^{⋁ *} \leq {z}_{i} \leq {z}_{i}^{⋀ *}$$

After having determined new operating points for each of the sub-networks i, the central agent 12 communicates the new strategies zᵢ^{g}* to each of them.

Then, during a step 130, each of the peripheral agents 10ᵢ receives, via the communication network, the operating point optimized overall for the external variables thereof: zᵢ^{g}*.

The objective herein is to optimize the internal control strategy of each of the components of the micro-network i while satisfying the overall trajectory as a new constraint imposed by the central agent.

Thus, the set of constraints is no longer as during step 110:

$${A}_{i} {x}_{i} + {B}_{i} {z}_{i} = {c}_{i}$$

And becomes:

$${A}_{i} {x}_{i} = {c}_{i} - {B}_{i} {z}_{i}^{g *}$$

The overall trajectory zᵢ^{g}* is now imposed. Same is thus no longer a variable on which the local agent can have an influence.

The cost function is also simplified, since it is now a question of minimizing the sole contribution of the internal variables:

min fₓ(xᵢ)

Step 130 thus corresponds to the resolution of the following second local optimization problem:

$${X}_{i}^{g *} = {arg min}_{{x}_{i}} {f}_{x} ( {x}_{i} )$$

$$s . t {A}_{i} {x}_{i} = {c}_{i} - {B}_{i} {z}_{i}^{g *}$$

The main drawback of such method is the absence of optimal overall control, knowing the internal costs that thereof may represent.

During step 120, the central agent decides on an overall trajectory and distributes same so as to move away from the local optimal trajectory in an identical manner for all the sub-networks.

However, for two different sub-networks, moving away from the local optimal trajectory does not have the same cost. For a first site, thereof may represent a slight degradation of the internal operating cost, whereas for a second site, thereof may represent a very significant degradation of the internal operating cost thereof.

The objective of the invention is then to propose an improved method of multilevel control by bands for solving the problem.

Indeed, the subject matter of the invention is a method, implemented by a computer, for multilevel control of an infrastructure including an electrical network and a control system of the electrical network, the electrical network aggregating a plurality of electrical sub-networks, the electrical sub-networks being connected to a common distribution network, and the control system including a plurality of peripheral agents and a central agent, the central agent being connected to the peripheral agents by a communication network, each peripheral agent being associated with a single electrical sub-network in order to locally control the operation of the associated electrical sub-network, and the central agent having overall control of the operation of the electrical network, the method including the steps of: determination, for each peripheral agent, of a first control strategy by performing a first local optimization, by implementing a i^{th} local cost function, on a set of control variables of the i^{th} electrical sub-network, said set of variables including, on the one hand, internal variables xᵢ, associated with components of the i^{th} electrical sub-network, and, on the other hand, external variables zᵢ associated with the connection point of the i^{th} electrical sub-network to the distribution network; transmission, to the central agent, of a first plurality of information including, for each electrical sub-network: the optimal local values of the external variables zᵢ^{l}*; the optimal local values of lower bounds of the external variables zᵢ^{∨}* and the optimal values of upper bounds of the external values zᵢ^{∧}* of the sub-network; determination, by the central agent, of an overall control strategy by performing an overall optimization on all the external variables zᵢ of the different electrical sub-networks; transmission, by the central agent, of a second plurality of information including, for each electrical sub-network, the overall optimal values of the external values zᵢ^{g}*; and, determination, for each peripheral agent, of a second control strategy by performing a second local optimization under constraint of the overall optimal values of the external values on the local variables xᵢ, the method being characterized in that the first plurality of information furthermore includes, additional information, the additional information including, for each electrical sub-network: a value of the i^{th} local cost function on local optimal values of the lower bounds of the internal variables fₓⁱ(xᵢ^{l}*); a value of the i^{th} local cost function on the local optimal values of the lower bounds of the internal variables fₓⁱ(xᵢ^{∨}*) and a value of the i^{th} local cost function on the local optimal values of the upper bounds of the internal variables fₓⁱ(xᵢ^{∧}*), and in that the determination, by the central agent, of an overall optimized control strategy takes into account the additional information for distributing the contribution of each sub-network to the overall optimized control strategy by taking into account, for each sub-network, a deviation of a i^{th} approximative cost on the first locally optimized control strategy between the local optimal values of the external variables overall optimal values of the external variables, the i^{th} approximative cost deriving from the additional information transmitted by the i^{th} peripheral agent.

According to other advantageous aspects of the invention, the method comprises one or a plurality of the following features, taken individually or according to all technically possible combinations:
the i^{th} approximative cost is a piecewise linear function including a lower segment connecting the point of coordinates zᵢ^{∨}* and fₓⁱ(xᵢ^{∨}*) and the point of coordinates zᵢ^{l}* and fₓⁱ(xᵢ^{l}*) and an upper segment connecting the point of coordinates zᵢ^{l}*; fₓⁱ(xᵢ^{l}*) and the point of coordinates zᵢ^{∧}* and fₓⁱ(xᵢ^{∧}*).
the overall optimization is written:

$$( {z}_{1}^{g *} , … , {z}_{i}^{g *} , … , {z}_{n}^{g *} ) = {arg min}_{{z}_{i}} g ( {z}_{i} )$$

the overall optimization being done by satisfying a set of overall constraints including the constraint:

zᵢ^{∨}≤zᵢ≤zᵢ^{∧}

with g an overall cost function reflecting the overall objective.
the overall cost function g includes a term associating the deviation of the i^{th} approximate cost (Fᵢ) for each sub-network.
the determination, by each peripheral agent, of a first control strategy by performing a first local optimization consists in:
solving locally a local optimization problem for determining the locally optimized control strategy for the micro-network:

$$( {x}_{i}^{l *} , {z}_{i}^{l *} ) = {arg min}_{{x}_{i} , {z}_{i}} {f}^{i} ( {x}_{i} ; {z}_{i} )$$

$$s . t {C}_{i} ( {x}_{i} ; {z}_{i} ) = 0$$

with fⁱ the i^{th} local cost function reflecting the local objective to be optimized by satisfying a set of local constraints Cᵢ, and xᵢ^{l}* the local optimal values of the internal variables;
solving two local optimization problems serving to determine, on the one hand, the upper flexibility bound and, on the other hand, the lower flexibility bound, for the previously determined locally optimal control strategy of the micro-network, i.e. for the lower bound

$$( {x}_{i}^{∨ *} , {z}_{i}^{∨ *} ) = {arg min}_{{x}_{i} , {z}_{i}} {α}_{i , f l e x}^{∨} ( {z}_{i}^{l *} - {z}_{i}^{∨} )$$

$$s . t . {C}_{i} ( {x}_{i}^{∨} ; {z}_{i}^{∨} ) = 0$$

$${f}^{i} ( {x}_{i}^{∨} ; {z}_{i}^{∨} ) \leq {α}_{i}^{∨} ( {f}^{i} ( {x}_{i}^{l *} ; {z}_{i}^{l *} ) ) + {β}_{i}^{∨}$$

and for the upper bound:

$$( {x}_{i}^{∧ *} , {z}_{i}^{∧ *} ) = {arg min}_{{x}_{i} , {z}_{i}} {α}_{i , f l e x}^{∧} ( {z}_{i}^{∧} - {z}_{i}^{l *} )$$

$$s . t . {C}_{i} ( {x}_{i}^{∧} ; {z}_{i}^{∧} ) = 0$$

$${f}^{i} ( {x}_{i}^{∧} ; {z}_{i}^{∧} ) \leq {α}_{i}^{∧} ( {f}^{i} ( {x}_{i}^{l *} ; {z}_{i}^{l *} ) ) + {β}_{i}^{∧}$$

where α_{i,flex}^{∨}, αᵢ^{∨}, βᵢ^{∨}, α_{i,flex}^{∧}, αᵢ^{∧} and βᵢ^{∧} are predefined coefficients, xᵢ^{∨}* the local optimal values of the lower bounds of the internal variables and xᵢ^{∧}* the local optimal values of the upper bounds of the internal variables.
the determination, by each peripheral agent, of a second locally optimized control strategy under constraint of the overall optimal values of the external variables zᵢ^{g}*, is written:

$${x}_{i}^{g *} = {arg min}_{{x}_{i}} {f}^{i} ( {x}_{i} )$$

$$s . t {C}_{i} ( {x}_{i} ; {z}_{i}^{g *} ) = 0$$

where fⁱ is the i^{th} local cost function translating the local objective to be optimized by satisfying a set of local constraints. Cᵢ and zᵢ^{g}* are the local optimal values of the internal variables of the second locally optimized control strategy.
the method further including a final step of controlling each component of the i^{th} sub-network according to the second control strategy.
The method is iterated for each time step.
the different iterations of the method allowing the i^{th} approximative cost to be specified.

The invention further relates to a computer program including software instructions which, when executed by a computer, implement a control method as defined hereinabove.

The invention will be clearer upon reading the following description, given only as an example, but not limited to, and making reference to the drawings wherein:

FIG. 1 is a schematic representation of a method of multi-level control by bands according to the prior art;

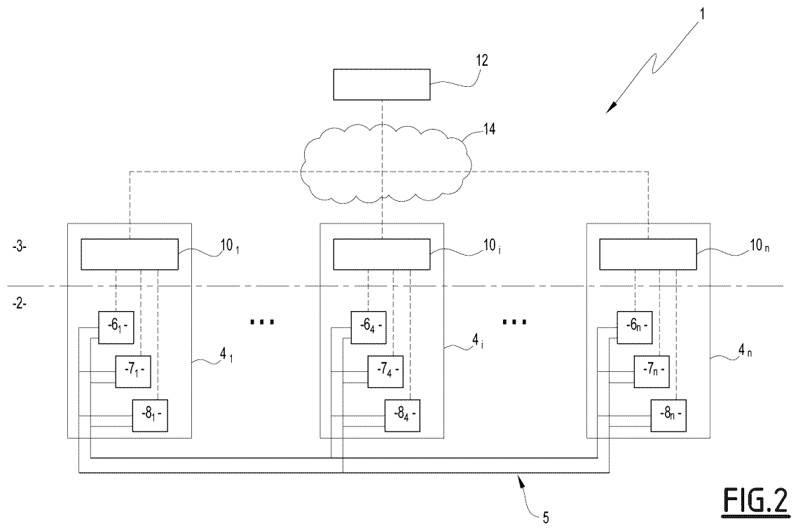

FIG. 2 is a schematic representation in the form of blocks of a system for implementing a method of multi-level control by bands according to the prior art or according to the invention;

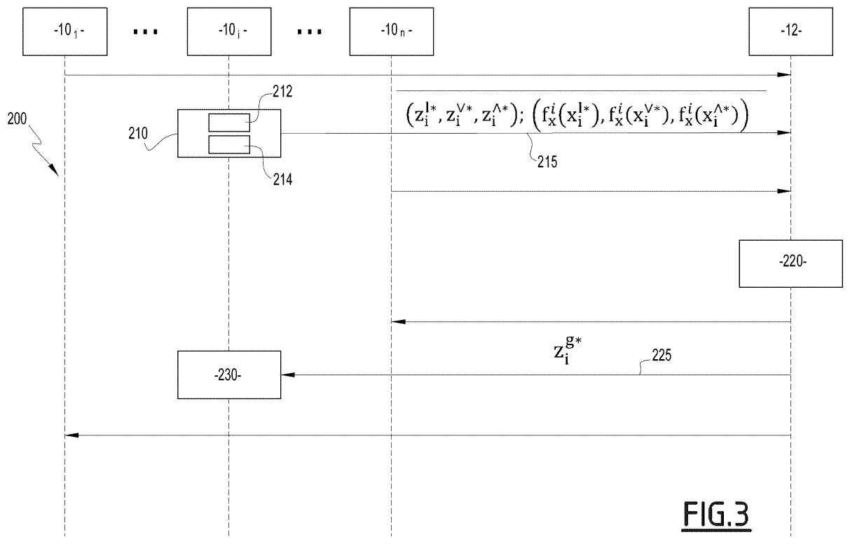

FIG. 3 is a schematic representation of a method of multi-level control by bands according to the invention; and,

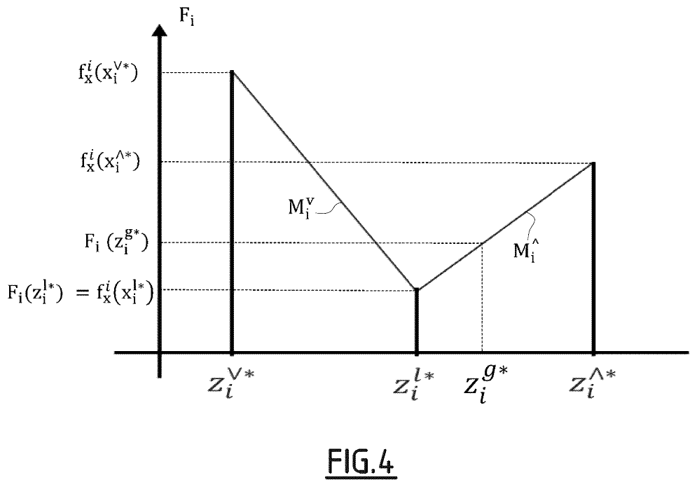

FIG. 4 is a graph illustrating the taking into account of the cost of flexibility for the overall optimization.

The method according to the invention is a multi-level control method by bands, with local control for each of the micro-networks and centralized overall control for the coordination of the different micro-networks.

The method is implemented in an infrastructure which will now be presented with reference to FIG. 2.

The infrastructure 1 includes an electrical network 2 and a control system 3 of the electrical network 2.

The electrical network 2 aggregates a plurality of electrical sub-networks 4ᵢ, where i is an integer index between 1 and n, n being the number of constituent sub-networks of the network 2.

For example, the micro-network 4₁ groups together a plurality of components, such as:
a PV unit 6₁ with a peak of 100 MW;
a residential building 7₁ of type B1 of which, part of the loads such as heating/air conditioning can be modulated upwards or downwards;
a slow charging station 8₁ for electric vehicles (possibility of charging offset), with some need for fast charging.

The micro-network 4ᵢ groups together a plurality of components, such as:
a PV unit 6ᵢ with a peak of 50 MW;
a stationary storage system 7₁ with a capacity of 5 MWh and a capacity of +/−1 MW at charge/discharge;
a charging station 8ᵢ for electric vehicles.

The micro-network 4ₙ groups a plurality of components such as:
a stationary storage system 6ₙ with a capacity of 10 MWh and a charge/discharge capacity of +/−1 MW;
a diesel generator 7ₙ, of 5 MW;
an industrial building 8ₙ with a production requiring large needs and a need for continuous power supply.

The sub-networks 4ᵢ are connected to a common distribution network 5. The latter may e.g. be itself connected to another network, such as a grid.

The control system 3 associates a plurality of peripheral agents 10 and a central agent 12.

The central agent 12 is connected to the peripheral agents 10ᵢ by a suitable communication network 14. The network 14 is e.g. an IP communication network, like the Internet. The central agent 12 and each peripheral agent 101 are thereby in two-way communication.

Each peripheral agent 10ᵢ equips a single electrical sub-network 4ᵢ to locally control the operation of the sub-network. Each peripheral agent 10ᵢ optimizes the operating variables of the micro-network at the local level.

Each peripheral agent 10ᵢ consists of at least one computer suitably programmed for implementing the method according to the invention. The computer includes e.g. a memory and a processor associated with the memory. The memory stores code instructions which, when executed by the processor, participate in the implementation of the method according to the invention.

The central agent 12 overall controls the operation of the entire network 2. The central agent 12 acts as coordinator. The central agent 12 consists of at least one computer suitably programmed for the implementation of the method according to the invention. The computer includes e.g. a memory and a processor associated with the memory. The memory stores code instructions which, when executed by the processor, participate in the implementation of the method according to the invention.

The central agent 12 is e.g. a service hosted in a cloud computing architecture. The central agent 12 can advantageously have a much greater computing power than same of the local agents 10ᵢ. As a result, it is possible to provide flexible services for network management that require significant computing power.

FIG. 3 represents schematically the method 200 according to the invention.

In general, the method 200 is an improvement of the method 100 of the prior art. The same notations introduced hereinabove for the method 100 are thus used hereinafter, in particular the notations for the internal and external variables, the cost functions, the constraints and the optimal values calculated for the variables and the bounds.

Each peripheral agent 10ᵢ calculates and transmits additional information to the central agent 12.

The additional information corresponds to evaluations of the degradation of the local objective considered during the local optimization, in particular for each of the two flexibility margins, upper and lower, respectively.

According to the method 200, each peripheral agent 10ᵢ first performs a first step 210.

Step 210 includes a first sub-step 212, followed by a second sub-step 214.

The first sub-step 212 consists in locally solving a first local optimization problem. The latter is simpler than the problem solved during the step 110 of the method 100.

Indeed, it is now sought to determine only the locally optimized control strategy for the micro-network 4ᵢ. Same can be written in a condensed way:

$$( {x}_{i}^{l *} , {z}_{i}^{l *} ) = {arg min}_{{x}_{i} , {z}_{i}} {f}_{x}^{i} ( {x}_{i} ) + {f}_{z}^{i} ( {z}_{i} )$$

$$s . t . {A}_{i} {x}_{i} + {B}_{i} {z}_{i} = {c}_{i}$$

More generally, the i^{th} local cost function is written:

fⁱ(xᵢ;zᵢ)
and the constraints are written:

Cᵢ(xᵢ;zᵢ)=0

During first sub-step 212, there is no calculation of the flexibility margin. Same will be calculated locally and separately in the next second sub-step 214.

The advantage of separating the optimization of local, internal and external variables into a plurality of steps is that the optimal trajectory thereby calculated is no longer influenced by the calculation of the flexibility bounds.

Indeed, in the prior art, depending on the coefficients α_{flex} chosen for the partial cost function, solving the flexibility bounds and the optimal trajectory in the same optimization problem may, in some cases, lead to degraded optimal solutions tending to maximize the flexibility margins to the detriment of the optimal trajectory.

The solution proposed herein does not suffer from such disadvantage since the optimal trajectory and the flexibility margins are treated independently and sequentially.

The control strategy calculated at the end of the first sub-step 212 is thus the most optimal possible control strategy for the micro-network 4ᵢ considered. Same leads to the determination of the values xᵢ^{l}* and zⱼ^{l}*.

The second sub-step 214 then consists in solving, still locally, two optimization problems serving to determine, on the one hand, the upper flexibility bound and, on the other hand, the lower flexibility bound for the locally optimal control strategy of the micro-network determined at 212.

Thereby, for the calculation of the lower bound on the external variables zᵢ, the optimization problem to solve is written:

$$( {x}_{i}^{∨ *} , {z}_{i}^{∨ *} ) = {arg min}_{{x}_{i} , {z}_{i}} {α}_{i , f l e x}^{∨} ( {z}_{i}^{l *} - {z}_{i}^{∨} )$$

$$s . t . {A}_{i} {x}_{i}^{∨} + {B}_{i} {z}_{i}^{∨} = {c}_{i}$$

$${f}_{x} ( {x}_{i}^{∨} ) + {f}_{z} ( {z}_{i}^{∨} ) \leq {α}_{i}^{∨} ( {f}_{x} ( {x}_{i}^{l *} ) + {f}_{z} ( {z}_{i}^{l *} ) ) + {β}_{i}^{∨}$$

And, for the calculation of the upper bound on the external variables zᵢ, the optimization problem to solve is written:

$$( {x}_{i}^{∧ *} , {z}_{i}^{∧ *} ) = {arg min}_{{x}_{i} , {z}_{i}} {α}_{i , f l e x}^{∧} ( {z}_{i}^{∧} - {z}_{i}^{l *} )$$

$$s . t . {A}_{i} {x}_{i}^{∧} + {B}_{i} {z}_{i}^{∧} = {c}_{i}$$

$${f}_{x} ( {x}_{i}^{∧} ) + {f}_{z} ( {z}_{i}^{∧} ) \leq {α}_{i}^{∧} ( {f}_{x} ( {x}_{i}^{l *} ) + {f}_{z} ( {z}_{i}^{l *} ) ) + {β}_{i}^{∧}$$

where the coefficients α_{i,flex}^{∧} and α_{i,flex}^{∨} can be the same or different for the upper and lower bounds and/or from one sub-network to another.

The additional constraint makes it possible to determine the bounds with a control of the acceptable degradation of the value of optimality. This control is carried out through the choice of coefficients αᵢ^{∨} and βᵢ^{∨}, on the one hand, and coefficients αᵢ^{∧} and βᵢ^{∧}, on the other hand.

Such improvement over the method 100 makes it possible to limit the flexibility bounds on values of the cost function that are locally acceptable (e.g. degradation of the comfort of the users of a building).

The separation of the calculation of the bounds into two sub-problems also makes it possible to parallelize the resolution process, in addition to reducing the complexity of the optimization problem, which leads to saving in resolution time and memory space needed for the calculations, which is an important advantage for deployment in a small local computation unit, such as the peripheral agent 101.

At the end of steps 212 and 214, each local agent 10ᵢ transmits (step 215) to the central agent 12, via the communication network 14, the following information:
the optimal control strategy for external variables zᵢ^{l}*;
the optimal control strategy for the lower flexibility bound of external variables zᵢ^{∨}*; and,
the optimal control strategy for the upper flexibility bound of external variables zᵢ^{∧}*, but also the following additional information:
the cost of the local optimal control strategy on internal variables fₓⁱ(xᵢ^{l}*);
the cost of the local optimal control strategy for the lower flexibility bound of internal variables fₓⁱ(xᵢ^{∨}*); and,
the cost of the local optimal control strategy for the upper flexibility bound of internal variables fₓⁱ(xᵢ^{∧}*).

In a variant, a local agent 101 can also transmit the cost of the local optimal control strategy on the external variables and the associated flexibilities bounds: f_{z}ⁱ(zᵢ^{l}*), f_{z}ⁱ(zᵢ^{∨}*), and f_{z}ⁱ(zᵢ^{∧}*). However, the central agent generally knows the cost f_{z}ⁱ for each of the external variables of the sub-networks, since the external variables are public and correspond to connection points on the common distribution network 5.

Step 220, carried out by the central agent 12, then consists in solving an overall optimization problem, with an overall cost function g reflecting the overall objective to be optimized, and satisfying all the constraints, in particular a new constraint on the flexibility bounds. The overall optimization problem to be solved is written:

$$( {z}_{1}^{g *} , … , {z}_{i}^{g *} , … , {z}_{n}^{g *} ) = {arg min}_{{z}_{i}} g ( z )$$

$$s . t . Dz = h$$

$${z}_{i}^{∨ *} \leq {z}_{i} \leq {z}_{i}^{∧ *}$$

The optimization problem solves two problems at once:
the first problem is to determine an overall optimal control trajectory for the entire system 2. The trajectory has the new constraint of having to be within the envelope defined by all the flexibilities margins of the micro-networks 10ᵢ:

zᵢ^{∨}*≤zᵢ≤zᵢ^{∧}*
the second problem is to distribute the overall control trajectory between the micro-networks, so as to determine, for each of the micro-networks 101, the participation thereof in the overall trajectory.

The resolution of the second problem is essential since it is necessary to make the right choices, i.e. decide which micro-network should increase/decrease the production/consumption thereof, by how much and at what time. The additional cost information communicated by each micro-network is then used to guide the distribution.

To this end, the additional information makes it possible to construct an approximate cost Fᵢ for each sub-network 10ᵢ. This is a piecewise linear function.

As shown e.g. in FIG. 4, in a simple embodiment, the i^{th} approximative cost Fᵢ consists of two segments.

A first lower line segment Mᵢ^{∨} connects the coordinate points (zᵢ^{∨}*; fₓⁱ(xᵢ^{∨}*)) and (zᵢ^{l}*; fₓⁱ(xᵢ^{l}*)), on the one hand, and a second upper line segment Mᵢ^{∧} connects the coordinate points (zᵢ^{l}*; fₓⁱ(xᵢ^{l}*)) and (zᵢ^{∧}*; fₓⁱ(xᵢ^{∧}*)), on the other hand.

At the minimum of the approximation, one has the relation Fᵢ(xᵢ^{l}*)=fᵢ(xᵢ^{l}*) and the maxima of the approximation are given for the permitted flexibility margins.

The approximative cost makes it possible to evaluate the impact of the deviation from the optimal trajectory on the internal cost of the i^{th} sub-network 4ᵢ between the local optimal values of the external variables zᵢ^{l}* and the overall optimal values of the external variables zᵢ^{g}*.

The use of such an approximation makes it possible to order the flexibilities of the micro-networks and to pass on the deviation calculated by taking into account the overall objective on the micro-networks for which the deviation has the minimum impact on the internal objective.

To this end, the cost function g can be divided into two parts

$$g = G l o b a l C o s t ( z ) + {\sum }_{i} InternalCost ( {z}_{i} )$$

With a first part, GlobalCost, corresponding to the savings coming from the coordinated participation of all the 4ᵢ sub-networks in the overall strategy, as a saving in revenues for participation in remunerative flexibility services.

The second part of the cost function g, Σᵢ InternalCost(zᵢ), corresponds to the estimation of internal costs, using the piecewise linear approximation, such as same in FIG. 4, for each overall control trajectory zᵢ, of a 4ⁱ sub-network, described hereinabove:

$$InternalCost ( {z}_{i} ) = {F}_{i} ( {z}_{i} ) - {F}_{i} ( {z}_{i}^{l *} )$$

Thereof leads to the overall optimization of the external variables zᵢ^{g}*, each of the values corresponding to a local cost Fᵢ(zᵢ^{g}*).

Finally, in step 225, the central agent 12 transmits the new operating point zᵢ^{g}* to each of the peripheral agents 10ᵢ.

Each of the peripheral agents 101 then implements step 230.

Said step is identical to step 130 of the method 100 of the prior art.

Thereby, each micro-network 4ᵢ computes the local optimal control strategy thereof so as to follow the imposed overall optimal control strategy:

$${x}_{i}^{g *} = {arg min}_{{x}_{i}} {f}_{x} ( {x}_{i} )$$

$$s . t {A}_{i} {x}_{i} = {c}_{i} - {B}_{i} {z}_{i}^{g *}$$

The peripheral agent 10ᵢ then controls the different components of the electrical sub-network 4ᵢ, using the zᵢ^{g}* as control setpoint value.

The method 200 is iterated for the next time step.

In a variant, the method 200 can be iterated for the same time step, in order to bring same closer to the optimal overall control solution.

Such variant makes it possible, at each iteration, to refine, for each of the micro-networks, the approximation of the cost of a deviation between the local trajectory and the overall trajectory.

Such more precise information allows the coordinator to refine the optimization of the overall trajectory and the participation of each micro-network in the overall strategy.

It should be emphasized that the local objective of one sub-network may be different from the local objective of another sub-network and especially from the overall objective of the network as a whole. Thereby, cost functions, including internal partial functions fₓⁱ, external partial functions f_{z}ⁱ and margin partial functions (coefficients α_{flex}ⁱ) have the index i of the sub-network that uses same.

The form of these partial functions can also depend on time in order to favor certain time steps of the time horizon, in particular time steps for which flexibility is significant. Thereby, the calculated flexibility is not constant over all the time steps but can vary over time. It is thus more appropriate to have more flexibility when the price of electricity is high and, on the other hand, less flexibility when the price of electricity is low. Thereof can also lead to an improvement in the operation of the electrical network, taking into account the physical constraints of the network, such as problems of line congestion, limitation on power transits, etc.

Thereby, according to the invention, the network coordinator has additional information enabling him/her to distribute the achievement of the overall objective among the different sub-networks.

It should be noted that if a micro-network indicates a large margin of flexibility, thereof does not provide information on the impact of deviation from the local optimal control strategy and on the degradation of its own local objective.

With the invention, the degradation of the local objective can be controlled so as to limit same.

The particular embodiment presented in detail hereinabove has the additional advantage of the possibilities of parallelizing (during step 214 of the method 200) the calculations by reducing the complexity of the problems treated, in particular in the first steps of local optimization.

In the particular embodiment presented in detail hereinabove, the functions provided by the agents, peripheral or central, are in the form of software, or of a software brick, executable by the processor of the associated computer. Furthermore, such software, or computer program, is apt to be recorded on a computer medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH or NVRAM) or a magnetic card. A computer program containing software instructions is then stored on the readable medium.

The method according to the invention finds many applications, such as:
aggregating a plurality of sites (micro-networks) with limited capacities and powers, to position the resulting coordinated network on flexible markets.
controlling a distribution network with PV production and local consumption to promote local consumption and avoid as much as possible the backflow of active power onto the transmission network. As a result therefrom, the stability of the transmission network and the overall management of the network is improved.

1. A method, implemented by computer, for multilevel control with bands of an infrastructure comprising an electrical network and a control system of the electrical network, the electrical network aggregating a plurality of electrical sub-networks, the electrical sub-networks being connected to a common distribution network, and the control system including a plurality of peripheral agents and a central agent, the central agent being connected to the peripheral agents by a communication network, each peripheral agent being associated with a single electrical sub-network in order to locally control the operation of the associated electrical sub-network, and the central agent overall controlling the operation of the electrical network, the method including the steps of:
determination, by each peripheral agent, of a first control strategy by performing a first local optimization, by implementing a i^{th} local cost function, on a set of control variables of the i^{th} electrical sub-network, said set of variables comprising, on the one hand, internal variables xᵢ associated with components of the i^{th} electrical sub-network, and, on the other hand, external variables zᵢ associated with the point of connection of the i^{th} electrical sub-network to the distribution network;
transmission, by each peripheral agent to the central agent, of a first plurality of information items including, for each electrical sub-network: the local optimal values of the external variables zᵢ^{l}*; the local optimal values of the lower bounds of the external variables zᵢ^{∨}*; and the optimal values of the upper bounds of the external variables zᵢ^{∧}* of the sub-network;
determination, by the central agent, of an overall control strategy by performing an overall optimization on all the external variables zᵢ of the different electrical sub-networks;
transmission, by the central agent to each peripheral agent, of a second plurality of information items including, for each electrical sub-network, the overall optimal values of the external variables zᵢ^{g}*; and,
determination, by each peripheral agent, of a second control strategy by performing a second local optimization, under constraint of the overall optimal values of the external variables (zᵢ^{g}*), on the internal variables xᵢ,
the method wherein the first plurality of information items further includes additional information, the additional information including, for each electrical sub-network: a value of the i^{th} local cost function on the local optimal values of the internal variables fₓⁱ(xᵢ^{l}*); a value of the i^{th} local cost function on the local optimal values of the lower bounds of the internal variables fₓⁱ(xᵢ^{∨}*); and a value of the i^{th} local cost function on the local optimal values of the upper bounds of the internal variables fₓⁱ(xᵢ^{∧}*),
and wherein the determination, by the central agent, of an overall optimized control strategy, takes into account the additional information to distribute the contribution of each sub-network to the overall optimized control strategy by taking into account, for each sub-network, a deviation of an i^{th} approximative cost (Fᵢ) on the first locally optimized control strategy between the local optimal values of the external variables (zᵢ^{l}*) and the overall optimal values of the external variables (zᵢ^{g}*), the approximate i^{th} cost deriving from the additional information transmitted by the additional information transmitted by the i^{th} peripheral agent.

2. The method according to claim 1, wherein the i^{th} approximative cost is a piecewise linear function having a lower segment connecting the coordinate point zᵢ^{∨}* and fₓⁱ(xᵢ^{∨}*) and the coordinate point zᵢ^{l}* and fₓⁱ(xᵢ^{l}*) and an upper segment connecting the coordinate point zᵢ^{l}*; fₓⁱ(xᵢ^{l}*) and the coordinate point zᵢ^{∧}* and fₓⁱ(xᵢ^{∧}*).

3. The method according to claim 1, wherein the overall optimization is written:
$$( {z}_{1}^{g *} , … , {z}_{i}^{g *} , … , {z}_{n}^{g *} ) = {arg min}_{{z}_{i}} g ( {z}_{i} )$$
the overall optimization being done by satisfying a set of overall constraints including the constraint:
zᵢ^{∨}*≤zᵢ≤zᵢ^{∧}*
with g an overall cost function reflecting the overall objective.

4. The method according to claim 3, wherein the overall cost function g includes a term associating the deviation of the i^{th} approximate cost (Fᵢ) for each sub-network.

5. The method according to claim 1, wherein the determination, by each peripheral agent, of a first control strategy by performing a first local optimization consists in:
locally solving a local optimization problem for determining the locally optimized control strategy for the micro-grid:
$$( {x}_{i}^{l *} , {z}_{i}^{l *} ) = {arg min}_{{x}_{i} , {z}_{i}} {f}^{i} ( {x}_{i} ; {z}_{i} )$$
$$s . t . {C}_{i} ( {x}_{i} ; {z}_{i} ) = 0$$
with fⁱ the i^{th} local cost function reflecting the local objective to be optimized by satisfying a set of local constraints Cᵢ, and xᵢ^{l}* the local optimal values of the internal variables;
solving two local optimization problems serving to determine, on the one hand, the upper flexibility bound and, on the other hand, the lower flexibility bound, for the previously determined locally optimal control strategy of the micro-network, i.e. for the lower bound:
$$( {x}_{i}^{∨ *} , {z}_{i}^{∨ *} ) = {arg min}_{{x}_{i} , {z}_{i}} {α}_{i , f l e x}^{∨} ( {z}_{i}^{l *} - {z}_{i}^{∨} )$$
$$s . t . {C}_{i} ( {x}_{i}^{∨} ; {z}_{i}^{∨} ) = 0$$
$${f}^{i} ( {x}_{i}^{∨} ; {z}_{i}^{∨} ) \leq {α}_{i}^{∨} ( {f}^{i} ( {x}_{i}^{l *} ; {z}_{i}^{l *} ) ) + {β}_{i}^{∨}$$
and for the upper bound:
$$( {x}_{i}^{∧ *} , {z}_{i}^{∧ *} ) = {arg min}_{{x}_{i} , {z}_{i}} {α}_{i , f l e x}^{∧} ( {z}_{i}^{∧} - {z}_{i}^{l *} )$$
$$s . t . {C}_{i} ( {x}_{i}^{∧} ; {z}_{i}^{∧} ) = 0$$
$${f}^{i} ( {x}_{i}^{∧} ; {z}_{i}^{∧} ) \leq {α}_{i}^{∧} ( {f}^{i} ( {x}_{i}^{l *} ; {z}_{i}^{l *} ) ) + {β}_{i}^{∧}$$
where α_{i,flex}^{∨}, αᵢ^{∨}, βᵢ^{∨}, α_{i,flex}^{∧}, αᵢ^{∧} and βᵢ^{∧} are predefined coefficients, xᵢ^{∨}* the local optimal values of the lower bounds of the internal variables and xᵢ^{∧}* the local optimal values of the upper bounds of the internal variables.

6. The method according to claim 1, wherein the determination by each peripheral agent, of a second locally optimized control strategy under constraint of the overall optimal values of the external variables zᵢ^{g}*is written as follows:
$${x}_{i}^{g *} = {arg min}_{{x}_{i}} {f}^{i} ( {x}_{i} )$$
$$s . t {C}_{i} ( {x}_{i} ; {z}_{i}^{g *} ) = 0$$
where fⁱ is the i^{th} local cost function translating the local objective to be optimized by satisfying a set of local constraints Cᵢ and zᵢ^{g}* are the local optimal values of the internal variables of the second locally optimized control strategy.

7. The method according to claim 1, including a final step of controlling each component of the i^{th} sub-network according to the second control strategy.

8. The method according to claim 1, the method being iterated for each time step.

9. The method according to claim 1, the method being iterated at the current time step, the different iterations being performed to specify the i^{th} approximative cost.

10. A computer program including software instructions which, when executed by a computer, implement a method according to claim 1.
